(19) United States
(12) Patent Application Publication
(10) Pub. No.: US 2015/0239141 A1
(43) Pub. Date: Aug. 27, 2015

(54) DEVICE AND METHOD FOR BREAKING OFF AND SEPARATING FINISHED PRODUCTS

(71) Applicant: KAMA GMBH, Dresden (DE)

(72) Inventors: Johannes Helbig, Radebeul (DE); Steffen Pieper, Dresden (DE)

(73) Assignee: KAMA GMBH, Dresden (DE)

(21) Appl. No.: 14/420,673

(22) PCT Filed: May 5, 2014
(86) PCT No.: PCT/EP2014/059044

§ 371 Date: Feb. 10, 2015

(30) Foreign Application Priority Data
May 3, 2013 (DE) 10 2013 208 189.8

(51) Int. Cl. B26D 7/18; B26F 1/38

(52) U.S. Cl. CPC B26D 7/18; B26F 1/38

(57) ABSTRACT

A device and a method suitable for a sheet punching and embossing machine, is employed for separating finished products and scrap material of a punched sheet while the sheet is moved in a transport direction, with the finished products and scrap material adjoining one another at punching lines. The device includes a break-off element which can be moved intermittently away from a second plane and towards the second plane between a break-off position and a rest position. The application of force onto the scrap material ends before the track of the applied force crosses an unevenly arranged punching line, and the application of force is resumed after the track of the applied force has crossed an evenly arranged punching line.

The invention relates to a device and a method for separating finished product and waste product of a punched sheet, which are adjacent to one another on punching lines, while the sheet is moving in a conveying direction, in particular for a sheet-fed punching and embossing machine.

Punching is the term used for cutting with inherently closed geometric blanking shapes which may be of any shape. Punching here is performed against a punching bed or against a die, wherein besides punching per se also score lines or embossings may additionally be sunk into the finished product. Packaging materials of paper, paperboard, cardboard, corrugated paperboard are mainly punched in sheet form, wherein on account of the complex operation sheets are individually punched.

In the case of known punching machines which may be implemented as both rotary punching machines, i.e. having a cylindrically configured punching tool, and also as flat-bed punching machines, having a planar punching tool, sheets which are stacked on a skid, for example, are infed to this punching machine. In the machine the sheets are initially aligned in an alignment direction and acquired by a gripper carriage which conveys the sheets onward to the punching tool in the punching unit. Subsequent to punching and other processing steps, the sheets are conveyed by the gripper to a device for breaking off the finished product from the sheet and for subsequent separating of the finished product. In breaking off, waste product is removed by breaking-off means. In separating finished product, the finished product is separated from the waste product.

Devices for breaking off and separating finished product, in which the sheet is stopped in the device between an upper tool and a lower tool, are known, wherein said devices are in each case populated by breaking-off pins. The breaking-off pins which are disposed so as to be congruent hold the waste product and push the latter through a breaking-off board, on account of which the retaining points between the finished product and the waste product tear. Setting up the breaking-off tool of the device here has to be performed manually and individually for the respective sheet. The number of breaking-off pins here may easily reach 500 pieces or more, on account of which the time expenditure for setting up is enormous and the productivity of the sheet-fed punching and embossing machine is compromised.

DE 10 2007 029 408 A1, as a refinement, describes a universal tool for sheet-fed punching and embossing machines, on account of which tooling times can be shortened. The universal tool, which is suitable for both breaking off and also separating finished product, to this end displays a piecing plate and a working plate, wherein these are in each case provided with mutually aligning holes. Pins are pluggable into these holes. The plates are individually adjustable for height and in each case display an arrester mechanism for jamming the pins. A breaking-off board or a separating mesh for the finished product may be assigned to the universal tools, wherein the former are immovable and in their design are adapted to the distribution of the finished product of the respective sheet. Depending on the design of the breaking-off board or of the separating mesh for the finished product, the pins can be jammed in the working plate. On account thereof, the tooling time can be shortened, but the breaking-off board and the separating mesh for the finished product have still to be adapted to the sheet which is being punched in each case, on account of which in turn long tooling times arise.

Another tool-free device and a method for breaking off and separating finished product, for example, is proposed in U.S. Pat. No. 6,467,382 B2. Here, the finished product is separated from the waste product during movement of the sheet, and the finished product is separated from the waste product. To this end, the punched sheet is inwardly conveyed to the device in a conveying plane and guided between infeed cylinders which are disposed in pairs on top of one another. The leading edge of the inwardly conveyed sheet is identified and by means of a movable cylinder which displays a width across the entire sheet width, transverse to the conveying direction, the leading edge is gripped and pushed downward. When being pushed downward, the leading edge of the sheet is pushed against the lower of the paired infeed cylinders by the movable cylinder, on account of which waste product can be drawn off in a downward manner, while the finished product is conveyed onward in the conveying plane by the drawing-off cylinders which are likewise disposed in pairs on top of one another. To this end, the movable cylinder is moved so as to be completely below the conveying plane, since otherwise the finished product could not be conveyed onward any more. Here, the fact that the sheet in its leading-edge region has to display a disproportionally wide strip of waste product in the conveying direction is primarily disadvantageous, since at the typical conveying speeds of two sheets per second there would otherwise not be enough time to move the movable cylinder in a downward manner, without finished product already hitting against the cylinder. On account thereof, material economics are compromised.

Moreover, devices for breaking off and separating finished product are known in which rollers, the width of which transverse to the conveying direction is substantially smaller than the sheet width, are disposed such that they continuously deflect waste product in a downward manner during the movement of the sheet. Since the rollers are rigidly disposed, attention has to be paid in the design of the distribution of the finished product on the sheet to a continuous web in the conveying direction of waste product always being considered on the sheet in the region of the rollers, since otherwise also finished product will be deflected downward through the rollers, likewise resulting in unsatisfactory material economics. Sheets on which finished product is undercut in the conveying direction cannot be broken off in such a device.

It is thus an object of the invention to state a device and a method which avoid the disadvantages known from the prior art, improve material economics, and which enable waste product and finished product to be separated from such sheets in which finished product is undercut in the conveying direction.

These objects are achieved by a device having the features of claim 1 and a method having the features of claim 8. Advantageous design embodiments are presented in the dependent claims and the following description.

A device for breaking off and separating finished product and waste product of a punched sheet, which are adjacent to one another on punching lines, in particular for a sheet-fed punching and embossing machine, while the sheet is moving in a conveying direction, is proposed. The device according to the invention comprises a first conveying unit for inward conveying of sheets along the conveying direction in a first plane at a first speed, having a continuous first belt which is guided along deflection rollers, and a holding-down means, wherein the holding-down means is pushable onto the first belt. The device furthermore comprises at least one breaking-off means for breaking off finished product from the sheet, wherein the at least one breaking-off means, in a second plane which is not parallel in relation to the first plane, is pushable onto the first belt. The device furthermore comprises a first drawing-off means for outward conveying of the waste product which is separated from the finished product in the second plane, wherein the first drawing-off means is pushable onto the first belt, and a second conveying unit, for outward conveying of finished product at a second speed in a third plane which is not parallel in relation to the second plane, having a continuous second belt which is guided along deflection rollers, and having a second drawing-off means, wherein the second drawing-off means is pushable onto the second belt.

The device according to the invention is distinguished in that the breaking-off means is movable in a clocked manner between a breaking-off position and a rest position, away from the second plane and toward the second plane.

According to the invention, the breaking-off means during breaking off of the finished product from the sheet is disposed in a breaking-off position which is substantially tangential to the second plane. The breaking-off means here may touch the first belt in the second plane. However, the breaking-off means in the breaking-off position may also be spaced apart from the second belt. In one design embodiment, the breaking-off means is implemented as a rotatable roller or cylinder, for example, while in another design embodiment it is implemented as a type of sliding block, wherein dynamic friction arises between the sliding block and the waste product.

If the breaking-off means is in the rest position, i.e. having a larger spacing from the first belt in the second plane than in the breaking-off position, then finished product can pass the breaking means, in the effective region of the breaking-off means, transverse to the conveying direction, in an unobstructed manner during the conveyance in the conveying direction from the first plane into the third plane, i.e. such that, for example, the finished product is conveyed in a non-contacting manner past the breaking-off means.

It is expedient for the first plane and the second plane to be disposed in relation to one another such that the path between the breaking-off position and the rest position is as small as possible, given other constructive conditions which have to be considered, such as, for example, enabling outward conveying of waste product. The optimal region is between a congruent and a perpendicular arrangement of the first plane and of the second plane. The smaller the path between the breaking-off position and the rest position, the less time required for moving the breaking-off means between these two positions. On account thereof, according to the invention, the advantage that the sheet in its leading edge region in the conveying direction may display a strip of waste product which, in comparison with the prior art, is narrower.

According to the invention it is moreover expedient for the breaking-off means to be movable in a clocked manner. The cycle is an arbitrary temporal succession of back-and-forth movements of the breaking-off means, between the breaking-off position and the rest position. The cycle expediently is adjustable such that the breaking-off means while breaking-off finished product from a sheet can be moved back-and-forth multiple times between the breaking-off position and the rest position.

In one design embodiment of the invention a sheet detector is disposed ahead of the holding-down means in the conveying direction. The sheet detector may be configured as an optical sensor in the form of a photodiode or an acoustic sensor in the form of an ultrasonic sensor, for example. Sensors which are based on other physical effects are employable according to the invention.

By means of the sheet detector the leading edge of a sheet being inwardly conveyed can be identified. Thereafter, the breaking-off means can be moved back-and-forth between the breaking-off position and the rest position at that cycle that is specific to the sheet. Identification of the leading edge of the sheet by the sheet detector thus fulfils the task of a trigger for releasing the movement of the breaking-off means which is predetermined by the cycle.

It is advantageous for a plurality of breaking-off means to be disposed so as to be transverse to the conveying direction. On account thereof, the effective region of a breaking-off means is variably adjustable in a transverse manner to the conveying direction. It is possible, on the one hand, for breaking-off means having in each case differently wide effective regions in the transverse direction to the conveying direction to be used, on the other hand, the breaking-off means may be disposed so as to be transverse to the conveying direction in almost any arbitrary position. This is enabled in that, according to the invention, in the effective region of the breaking-off means on the sheet no continuous web in the conveying direction has to be considered, since breaking-off means are movable in a clocked manner between a breaking-off position and a rest position. On account thereof, according to the invention, finished product can also be broken off from such sheets which have finished product which is undercut in the conveying direction. To this end it may be provided that the plurality of breaking-off means are in each case movable in cycles which are independent of one another.

It is expedient for the first speed and the second speed to be identical. This is advantageous for breaking off and separating finished product for folding boxes, for example. Since no relative speed between already partially broken off finished product and waste product exists here, breaking off is completed merely by deflection of the waste product into the second plane. If finished product is broken off from a sheet having a larger material thickness in comparison with the preceding exemplary embodiment of the folding box, it may, however, also be provided that the second speed is higher than the first speed. On account thereof, apart from the deflection of waste product from the first plane into the second plane, finished product may also be torn from the waste product in the conveying direction, since a relative speed in the conveying direction exists between the finished product and the waste product.

The sheet, the finished product, and the waste product move on account of the power transmission from the first belt onto the sheet and the waste product and on account of the power transmission from the second belt onto the finished product. In order to increase the force of adhesive friction between the sheet, the finished product, the waste product, and the respective belt, it is expedient to push the sheet, the finished product, and the waste product, onto the respective belt using a normal force which is additional to the dead weight. It is, therefore, provided in one design embodiment of the invention that forces by way of which the holding-down means and the first drawing-off means are pushable in the direction of the first belt and the second drawing-off means is pushable in the direction of the second belt are in each case individually adjustable. It may be provided to this end that the holding-down means and/or the first drawing-off means and/or the second drawing-off means are pushable by means of a spring force in the direction of the first or second belt, respectively. In order to adjust the spring force the pretension of the spring, for example a helical spring, may be modified, for example.

Depending on the use of their finished product, sheets may display various material thicknesses. In order for sheets, waste product, and finished product to be able to be reliably drawn in between the holding-down means, the first drawing-off means, the second drawing-off means, and the respective belt, it may be provided in one design embodiment of the invention that the size of a gap between the holding-down means and the first belt and/or between the first drawing-off means and the first belt and/or between the second drawing-off means and the second belt is in each case individually adjustable. Here, the adjustable spacing is preferably smaller than the material thickness of the sheet.

In one design embodiment of the invention the first drawing-off means is configured as a resiliently mounted roller, wherein a gap is adjustable between this roller and the first belt. However, the gap is smaller than the material thickness of the sheet. In the event of there being no waste product between this roller and the first belt, there is likewise a gap between this roller and the second belt. The diameter of the roller in one design embodiment of the invention may be selected such that in the event of there being waste product between the roller and the first belt, the roller is also pushed against the second belt. In the case of sufficiently high normal forces, on account thereof a force may also be transmitted from the second belt to the roller and from the roller to the waste product. It is thus advantageous for the first drawing-off means to be designed such that a force fit between the first belt and the second belt is adjustable.

On account of the device according to the invention, the required tooling times for breaking off and separating finished product from another sheet, i.e. having another distribution of finished product and waste product, can be significantly reduced. To this end, the breaking-off means are merely to be placed in a transverse manner to the conveying direction at provided positions, and the cycles required for the breaking-off means to be selected from a memory of a control unit, for example. In this way, the positions of the breaking-off means and the respective cycles for a multiplicity of diverse sheets can be stored in the control unit. By way of visual and/or acoustic instructions, for example, the operator of the device according to the invention may then be guided through the retooling of the device.

Furthermore, a method for breaking off and separating finished product and waste product of a punched sheet, which are adjacent to one another on punching lines, while the sheet is moving in a conveying direction, is proposed.

The method here comprises conveying the sheet in a first plane, breaking off the finished product from the waste product by deflecting the waste product from the first plane into a second plane which is not parallel in relation to the first plane, and onward conveying of the waste product in the second plane, and onward conveying of the finished product in a third plane which is not parallel in relation to the second plane. Here, deflecting of the waste product from the first plane into the second plane is performed by punctiform application of force on the waste product at at least one stationary application point, wherein the waste product, on account of its movement in the conveying direction, is conveyed along an application track which is parallel with the conveying direction, past the application point.

In principle, punching lines may be disposed on the sheet in any arbitrary direction, wherein, however, those punching lines which outwardly delimit a finished product always form a closed curved profile on the sheet. According to the prior art, an application of force may be generated by rotatable rollers which are rigidly disposed, for example. Therefore, attention has to be paid in the design of the distribution of the finished product on the sheet that always a web of waste product which is continuous in the conveying direction is considered on the sheet in the region of the point of application of force, since otherwise finished product is also deflected downward by the application of force. Therefore, it is impossible to dispose punching lines which are transverse to the conveying direction in the region of the web.

The method is distinguished in that an application of force on the waste product is terminated before the application track intersects a punching line of an odd order, and the application of force is renewed once the application track has intersected a punching line of an even order.

The application point remains stationary in relation to the device according to the invention, since said application point represents that point on which the punctiform application of force on the waste product takes place. Following termination and renewal of the application of force the application point, in relation to the device according to the invention, is disposed at the same position as prior to the termination of the application of force.

On account of the proposed method, the material economics of the former may be noticeably improved, since in the application of the method finished product can be distributed on the sheet such that the proportion of the waste product on the sheet is minimized, that is to say also such that punching lines intersect application tracks in a transverse manner to the conveying direction.

In the case of punching lines which intersect application tracks, a defined number of punching lines which intersect the application track of the application point exists for each application track. Each application track may display a different number of punching lines which intersect the application track. Starting from the leading edge of the sheet and going counter to the conveying direction, said punching lines may be in each case counted separately for each application track, such that punching lines of an odd order, for example those of the first, third, fifth order, and punching lines of an even order, for example of the second, fourth, sixth order, result.

On account of the application of force on the waste product being terminated before the application track intersects a punching line of an odd order, the finished product can be conveyed onward from the first onto the third plane. If the application track intersects a punching line of an even order, the application of force is renewed, on account of which waste product is again deflected from the first into the second plane.

It is expedient for the leading edge of the sheet in the first plane to be identified ahead of the at least one application point by a sheet detector. The identification of the leading edge of the sheet is a type of trigger by way of which a temporal succession of termination and renewal of the application of force on the waste product is initiated. This temporal succession is referred to as a cycle.

It is expedient for a cycle for the application of force to be terminated and to be renewed to be pre-adjusted for the respective sheet. On account thereof, not each punching line which intersects an application track has to be individually identified. However, according to the invention, identification of punching lines by using a further sensor is possible.

In order to further increase the freedom of design when distributing the finished product on the sheet and to thus improve material economics, it may be provided that the applications of force are terminated and renewed at at least two application points which are associated with parallel application tracks, by cycles which are independent of one another.

An exemplary embodiment of the described device and of the method are explained in more detail herebelow by means of drawings, in which:

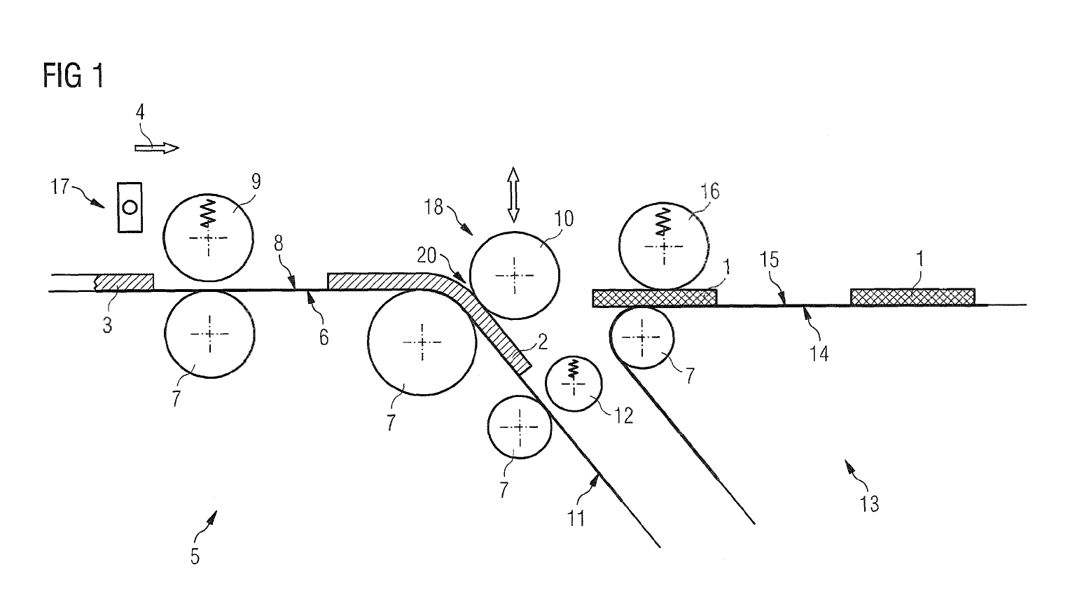

FIG. 1 shows a schematic illustration of the cross section of a device according to the invention for breaking off and separating finished product, wherein a breaking-off means is located in a breaking-off position, and

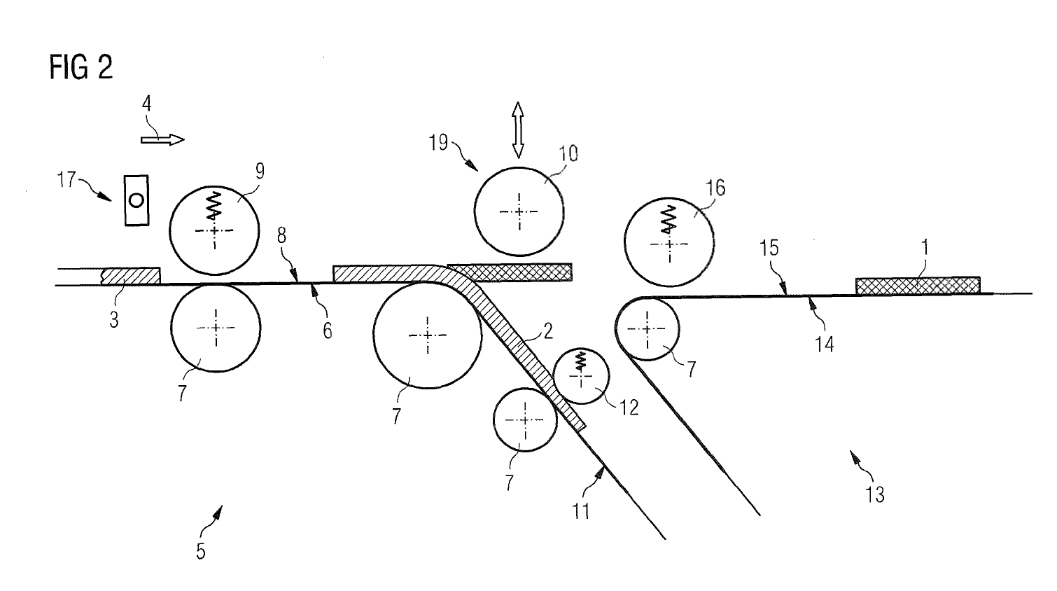

FIG. 2 shows a schematic illustration of the cross section of a device according to the invention, according to FIG. 1, wherein the breaking-off means is located in a rest position.

FIGS. 1 and 2 both show a schematic illustration of the same preferred embodiment of the device according to the invention, however in different states. While the breaking-off means 10 in FIG. 1 is disposed in a breaking-off position 18, the breaking-off means 10 in FIG. 2 is disposed in a rest position 19.

The device according to the invention may be employed in sheet-fed punching and embossing machines, in particular. The device here may be implemented as a functional group which is removable from the sheet-fed punching and embossing machine or form a rigidly connected unit with the sheet-fed punching and embossing machine, which is only demountable for shipping purposes, for example. Since breaking off and separating finished product are subsequent to the punching and/or embossing process per se, the device according to the invention is downstream of the punching and/or embossing tool when viewed in the conveying direction 4 of the sheet 3, wherein other functional groups of the sheet-fed punching and embossing machine, besides the device according to the invention per se, are not illustrated in FIGS. 1 and 2.

In FIGS. 1 and 2, on the left side in each case a first conveying unit 5 and, to the right thereof, a second conveying unit 13 are illustrated. While the sheet 3 is conveyed inward to the sheet-fed punching and embossing machine from a functional group which is upstream of the device according to the invention by the first conveying unit 5, and the waste product 2 is conveyed outward after breaking off, a finished product 1 is conveyed outward by the second conveying unit 13. Here, the first conveying unit 5 and the second conveying unit 13 may be implemented as separate functional groups, such that the device according to the invention can be readily separated, for example in order for maintenance or adjustment work to be performed on otherwise inaccessible regions of the first conveying unit 5 and/or of the second conveying unit 13.

The first conveying unit 5 comprises a continuous first belt 8 which is guided along deflection rollers 7, wherein the first belt 8 is illustrated only in portions and, therefore, the illustration of further deflection rollers 7 is also dispensed with. Moreover, the first conveying unit 5 comprises a drive unit (not illustrated) by means of which the first belt 8 is movable at a first speed.

The second conveying unit 13 comprises a continuous second belt 15 which is guided along deflection rollers 7, wherein the second belt 15 is illustrated only in portions and, therefore, the illustration of further deflection rollers 7 is also dispensed with. Moreover, the second conveying unit 13 comprises a drive unit (not illustrated) by means of which the second belt 15 is movable at a second speed.

The first speed and the second speed are adjustable independently of one another. Depending on which material or which material combination is displayed by the sheet 3, the first speed and the second speed may be adjusted to be identical or such that the second speed is higher than the first speed.

In the following, the device according to the invention and the method according to the invention are to be illustrated by means of FIGS. 1 and 2, wherein breaking off and separating finished product from a sheet 3 while conveying the sheet 3 through the device according to the invention is explained.

The sheet 3, being processed using a punching tool, after punching and/or embossing leaves the region of the punching and/or embossing tool of the sheet-fed punching and embossing machine, which region is not to be counted as being part of the device according to the invention, and is disposed on the first belt 8 of the first conveying unit 5. The sheet 3 may display a plurality of punching lines which are disposed so as to be transverse to the conveying direction 4. The first belt 8 conveys the sheet 3 at the first speed in the first plane 6. The leading edge of the sheet 3 is identified by means of the sheet detector 17. This information is transmitted to a control unit (not illustrated) of the device according to the invention.

The sheet 3 consequently reaches the holding-down means 9 which may be configured as a roller, a cylinder, a ball, or similar. The holding-down means 9, which is adjustable for height in relation to the first plane 6, is disposed so as to be spaced apart from the first belt 8. On account of the adjustability for height of the holding-down means 9, it is possible to react in an individual manner to various material thicknesses of sheets 3, such that their intake into the holding-down means 9 is ensured. Once the sheet 3 has been drawn into the holding-down means 9, the latter exerts an adjustable force in the direction of the first plane 6 onto the sheet 3. The force is adjusted such that good adhesive contact between the sheet 3 and the first belt 8 is established, i.e. that a sufficiently large force of adhesive friction for conveying the sheet 3 is established. On the other side of the first belt 8 a deflection roller 7, which is rigidly mounted but rotatable, is placed so as to oppose the holding-down means 9.

The sheet 3 consequently reaches the breaking-off means 10. A plurality of breaking-off means 10 may be disposed beside one another so as to be transverse to the conveying direction 4. The number of the breaking-off means 4 is merely limited by the installation space which is in each case required in a transverse manner to the conveying direction 4 and by the maximum available width of the first belt 8. The breaking-off means 10 preferably is configured as a roller or a cylinder. However, in another design embodiment, the breaking-off means 10 may also be implemented as a sliding block. The breaking-off means 10 is disposed so as to be movable. By means of an actuator (not illustrated), the breaking-off means 10 may be moved away from the first belt 8 and back toward the first belt 8 again. The actuator may be configured as a pneumatic, electric, hydraulic or other actuator, for example, which in turn is supplied with power and is connected to the control unit.

In FIG. 1 the breaking-off means 10 is illustrated in its breaking-off position 18, i.e. so as to be moved toward the first belt 8. In contrast, in FIG. 2 the breaking-off means 10 is illustrated in its rest position 19, i.e. so as to be moved away from the first belt 8.

Once the sheet 3 has reached the breaking-off means 10, the breaking-off means 10 acquires the leading edge of the sheet 3, which in the region of the leading edge displays waste product 2 across its entire width which is transverse to the conveying direction 4, and deflects the waste product 2 into a second plane 11 which is not parallel in relation to the first plane 6. On the other side of the first belt a deflection roller 7, which is rigidly mounted but rotatable, is placed so as to oppose the breaking-off means 10. All breaking-off means 10 are located in the breaking-off position 18.

While the sheet 3 keeps moving onward on the first belt 8, the waste product 2 is deflected downward into the second plane 11, wherein finished product 1 keeps on moving onward in the conveying direction in the first plane 6, until said finished product reaches the second belt 15 of the second conveying unit 13 in a third plane 14 which is not parallel in relation to the second plane 11. The third plane 14 preferably is disposed so as to be below the first plane 6, since the finished product 1, on account of its elasticity and the dead weight acting thereon, flexes while being conveyed from the first belt 8 to the second belt 15.

If the breaking-off means 10 are located in the breaking-off position 18, and if waste product 2 is disposed between the breaking-off means 10 and the first belt 8, this is enabled by a punctiform application of force on the waste product 2 at a stationary application point 20, while the waste product 2, on account of its movement in the conveying direction 4 along an application track which is parallel in relation to the conveying direction 4, is conveyed past the application point 20. If a breaking-off means 10 is located in the breaking-off position 18, no finished product can be conveyed in the region of the application track of this breaking-off means 10 from the first belt 8 to the second belt 15, since the path is blocked by the breaking-off means 10. Merely finished product 1 which is disposed in a transverse manner to the conveying direction 4 between the breaking-off means or their application tracks, respectively, can be conveyed from the first belt 8 to the second belt 15 when breaking-off means 10 are disposed in the breaking-off position 18.

As a consequence of the sheet 3 being conveyed in the conveying direction 4, punching lines which in the further course would intersect the application track of this breaking-off means 10 may also approach the breaking-off means 10. Starting from the leading edge of the sheet 3 and going counter to the conveying direction 4, intersecting punching lines for each application track may be in each case counted separately, such that punching lines of an odd order, for example the first, third, fifth order etc., and punching lines of an even order, for example the second, fourth, sixth order etc., result.

In order for finished product 1 which is located counter to the conveying direction 4 behind a punching line of an odd order to be able to be conveyed from the first belt 8 to the second belt 15, the application of force on the waste product 2 is terminated before the application track intersects a punching line of an odd order and the application of force is renewed once the application track has intersected a punching line of an even order.

On account of the individual arrangement of the finished product 1 on the sheet 3, a dedicated cycle is in each case created for each application track of a sheet 3, wherein the cycle is an arbitrary temporal succession of back-and-forth movements of the breaking-off means 10 between the breaking-off position 18 and the rest position 19. The cycle sequence for an individual sheet 3 is thus predeterminable and storable in the control unit (not illustrated). By means of the item of information stored by means of the sheet detector 17 in the control unit, that a sheet is approaching the breaking-off means 10, the breaking-off means 10 thereupon can be activated by means of the actuators (not illustrated), using the cycle of the respective breaking-off means 10, and the back-and-forth movement of the breaking-off means 10 can be effected.

Waste product 2 which is conveyed onward on the first belt 8 consequently approaches a first drawing-off means 12 which may be configured as a roller or a cylinder, respectively. The first drawing-off means 12 which is adjustable for height in relation to the second plane 11 is disposed so as to be spaced apart from the first belt 8. On account of the adjustability for height of the first drawing-off means 12 it is possible to react in an individual manner to various material thicknesses of sheets 3, such that their intake into the first drawing-off means 12 is ensured. Once the sheet 3 has been drawn into the first drawing-off means 12, the latter exerts an adjustable force in the direction of the second plane 11 on the sheet 3. The force is adjusted such that good adhesive contact between the sheet 3 and the first belt 8 is established, i.e. that a sufficiently large force of adhesive friction for conveying the sheet 3 is established. On the other side of the second belt 15 a deflection roller 7, which is rigidly mounted but rotatable, is placed so as to oppose the first drawing-off means 12.

Finished product 1 which is conveyed from the first belt 8 to the second belt 15 consequently approaches a second drawing-off means 16 which may be configured as a roller or a cylinder, respectively. The second drawing-off means 16 which is adjustable for height in relation to the third plane 14 is disposed so as to be spaced apart from the first belt 8. On account of the adjustability for height of the second drawing-off means 16 it is possible to react in an individual manner to various material thicknesses of sheets 3, such that their intake into the second drawing-off means 16 is ensured. Once the sheet 3 has been drawn into the second drawing-off means 16, the latter exerts an adjustable force in the direction of the third plane 14 on the sheet 3. The force is adjusted such that good adhesive contact between the sheet 3 and the second belt 15 is established, i.e. that a sufficiently large force of adhesive friction for conveying the sheet 3 is established. On the other side of the second belt 15 a deflection roller 7, which is rigidly mounted but rotatable, is placed so as to oppose the second drawing-off means 16.

The described method is consequently repeated for each inwardly conveyed sheet 3.

When changing to a sheet 3 which displays another distribution of finished product and waste product, the device according to the invention has to be retooled. To this end, breaking-off means 10 may be freely positioned in a transverse manner to the conveying direction 4. The number of breaking-off means 10 is variable and is adaptable to the respective sheet 3. Merely the extent of the breaking-off means 10 in a transverse manner to the conveying direction 4 has a limiting effect on the maximum number of breaking-off means 10 which are usable. Once the number and the position of the breaking-off means 10 have been modified, the cycles required for the breaking-off means 10 may be selected, for example from the memory of the control unit. In this way both the positions of the breaking-off means 10 and also the respective cycles for a multiplicity of diverse sheets 3, may be stored in the control unit.

### LIST OF REFERENCE SIGNS

1 Finished product
2 Waste product
3 Sheet
4 Conveying direction
5 First conveying unit
6 First plane
7 Deflection roller
8 First belt
9 Holding-down means
10 Breaking-off means
11 Second plane
12 First drawing-off means
13 Second conveying unit
14 Third plane
15 Second belt
16 Second drawing-off means
17 Sheet detector
18 Breaking-off position
19 Rest position
20 Stationary application point

1. A device for breaking off and separating finished product and waste product of a punched sheet, which are adjacent to one another on punching lines, while the sheet is moving in a conveying direction, in particular for a sheet-fed punching and embossing machine, comprising
a first conveying unit for inward conveying of sheets along the conveying direction in a first plane at a first speed, having a continuous first belt, which is guided along deflection rollers, and a holding-down means, wherein the holding-down means is pushable onto the first belt,
at least one breaking-off means for breaking off finished product from the sheet, wherein the at least one breaking-off means, in a second plane which is not parallel in relation to the first plane, is pushable onto the first belt,
a first drawing-off means for outward conveying of the waste product which is separated from the finished product in the second plane, wherein the first drawing-off means is pushable onto the first belt, and
a second conveying unit, for outward conveying of finished product at a second speed in a third plane which is not parallel in relation to the second plane, having a continuous second belt which is guided along deflection rollers, and having a second drawing-off means, wherein the second drawing-off means is pushable onto the second belt, wherein the breaking-off means is movable in a clocked manner between a breaking-off position and a rest position, away from the second plane and toward the second plane.

2. The device as claimed in claim 1, wherein a sheet detector is disposed ahead of the holding-down means in the conveying direction.

3. The device as claimed in claim 1, wherein a plurality of breaking-off means are disposed so as to be transverse to the conveying direction, wherein the plurality of breaking-off means are in each case movable in cycles which are independent of one another.

4. The device as claimed in claim 1, wherein the first speed and the second speed are identical.

5. The device as claimed in claim 1, wherein forces by way of which the holding-down means and the first drawing-off means are pushable in the direction of the first belt and the second drawing-off means is pushable in the direction of the second belt are in each case individually adjustable.

6. The device as claimed in claim 1, wherein size of a gap between the holding-down means and the first belt and/or between the first drawing-off means and the first belt and/or between the second drawing-off means and the second belt is in each case individually adjustable.

7. The device as claimed in claim 1, wherein the first drawing-off means is designed such that a force fit between the first belt and the second belt is adjustable.

8. A method for breaking off and separating finished product and waste product of a punched sheet, which are adjacent to one another on punching lines, while the sheet is moving in a conveying direction, comprising
conveying the sheet in a first plane,
breaking off the finished product from the waste product by deflecting the waste product from the first plane into a second plane which is not parallel in relation to the first plane, and onward conveying of the waste product in the second plane,
onward conveying of the finished product in a third plane which is not parallel in relation to the second plane,
wherein deflecting of the waste product from the first plane into the second plane is performed by punctiform application of force on the waste product at at least one stationary application point, and the waste product, on account of its movement in the conveying direction, is conveyed along an application track which is parallel with the conveying direction, past the application point, wherein the application of force on the waste product is terminated before the application track intersects a punching line of an odd order, and the application of force is renewed once the application track has intersected a punching line of an even order.

9. The method as claimed in claim 8, wherein a leading edge of the sheet in the first plane is identified ahead of the at least one application point by a sheet detector.

10. The method as claimed in claim 8, wherein a cycle for the application of force to be terminated and to be renewed is pre-adjusted for the respective sheet.

11. The method as claimed in claim 8, wherein the applications of force are terminated and renewed at at least two application points which are associated with parallel application tracks, by cycles which are independent of one another.
